(19) United States
(12) Patent Application Publication
(10) Pub. No.: US 2002/0184924 A1
(43) Pub. Date: Dec. 12, 2002

(54) Recoating method for optical fiber

(76) Inventors: Yun Jong Choi, Sakura-shi (JP); Yoshinori Kanai, Sakura-shi (JP); Junichi Suzuki, Sakura-shi (JP)

Correspondence Address: Robert M. Barrett, Esq., Bell, Boyd & Lloyd LLC, P.O. Box 1135, Chicago, IL, 60690-1135, US

(21) Appl. No.: 10/165,729

(22) Filed: Jun. 7, 2002

(30) Foreign Application Priority Data
Jun. 12, 2001 (JP) 2001-176721

(51) Int. Cl. C03C 25/36

(52) U.S. Cl. 65/432; 65/473

(57) ABSTRACT

A recoating method for an optical fiber recoats a uniform thickness of resin on a covering-resin-removed-area of an optical fiber. The covering-resin-removed-area is rotated relatively to a resin supplying device while supplying the resin to the covering-resin-removed-area.

### BACKGROUND OF THE INVENTION

1. Field of the Invention

The present invention relates to a method for recoating an optical fiber from which a covering-resin has been removed. The invention particularly relates to a method for forming a recoated resin of uniform thickness.

2. Description of the Related Art

For the purpose of protecting the area at which the resin of an optical fiber has been removed, such as at a connection part of an optical fiber by welding where a cover layer of the optical fiber is removed, recoating is performed to provide a covering-resin.

Conventionally, there are two basic methods for recoating an optical fiber. One method is illustrated in FIG. 4. In this method, first, an optical fiber 10 which has a covering-resin-removed-area 12 where a coated section 11 has been removed is retained vertically by the vertical clamps 21 and 21 of a recoating device 20.

Next, while maintaining this position, dies 22 for recoating the resin are attached on a coated section 11 below a section from which the coating is removed, and the resin hardening device 23 emits radiation such as UV (ultraviolet) light. Then, while supplying a melted resin such as UV curable resin to dies 22, the dies 22 are raised. By this operation, the outer diameter of a recoated section 11a, which is approximately the same as the coated section 11, is formed gradually upward. At this time, the resin hardening device 23 is elevated together with the ascension of the dies 22, and the resin 1 is hardened upwardly by the radiation of UV light. By this operation, a recoated section 11a is formed on the covering-resin-removed-area 12 which is between the upper and lower coated sections 11.

Another method is shown in FIGS. 5 and 6. In this method, first, an optical fiber 10 which has covering-resin-removed-area 12, where the coated section 11 has been removed, is retained from both sides by the clamps 31 and 31 of the recoating device 30, although the clamping is performed horizontally, in contrast to the case if FIG. 4.

While maintaining this position, glass dies (bottom die and top die) 32 and 33 for recoating the resin are set between the coated sections 11 and 11 which are on both sides of the covering-resin removed section 12, and the resin hardening device 34 which emits radiation such as UV light is set along the dies 32 and 33. Then, the melted resin, such as UV curable resin, is supplied to grooves 32a and 33a of the dies 32 and 33 from a resin supply port 32b of the bottom die 32, and UV light is emitted from the resin hardening device 34 which is along the glass dies 32 and 33, and thus the UV curable resin is hardened inside the dies. The die 32 and 33 may be removed after the hardening of the resin is completed. By this operation, the recoated section 11a is formed on the covering-resin-removed-area 12 which is between the two coated sections 11 and 11.

However, it was difficult to obtain a uniform diameter over the entirety of recoated section 11a, as shown in FIG. 7, because of the characteristics of the resin, such as liquidity, depending on the viscosity and behavior under the influence of gravity in the method illustrated by FIG. 4. The problem was, for example, that the diameter of the covering-resin-removed-area 12 decreased particularly in the lower part of the covering-resin-removed-area 12, and thus the diameter was not uniform.

In order to prevent such an occurrence, more precise control is necessary in operations such as temperature control of resin, movement control of the dies 22, and timing control of UV light radiation by the resin hardening device 23; however, the cost was inevitably increased due to such operations. Also, even if such precise control is performed, it is difficult to eliminate the nonuniform part from the outer diameter made from the melted resin because the recoated section Ha is formed vertically.

On the other hand, it was difficult to obtain a uniform diameter of the recoated section Ha along the horizontal direction as shown in FIGS. 8 and 9 because of the above characteristics of the resin in the method illustrated in FIGS. 5 and 6. The problem is, for example, that the upper part of the recoated section 11a was thin and the lower part was thick, and thus the thickness tended to be unequal. In particular, the thickness of the part which overlaps on the coated section 11 became quite small, thus the equalization of the thickness tended to be difficult.

This unequal thickness can also be caused by factors in the die such as inadequate centering accuracy of the optical fiber 10 and the glass die, inappropriate shape of the die, as well as the above characteristics of the resin. Therefore careful attention and precise control are necessary in the setting of these factors.

The invention was made in view of these circumstances. The invention provides a recoating method for an optical fiber by which factors, such as resin characteristics, inadequate centering of optical fibers, and inappropriate shape of the glass dies can be minimized by rotating the covering-resin-removed-area relatively to the resin supplying device when supplying the resin to the covering-resin-removed-area, and thus a uniformly recoated section can be obtained.

### SUMMARY OF THE INVENTION

In a recoating method for optical fibers according to a first aspect of the present invention, a covering-resin-removed-area where the covering-resin of an optical fiber has been removed is recoated and the covering-resin-removed-area is rotated relative to the resin supplying device while supplying the resin to the covering-resin-removed-area.

In a recoating method for optical fibers according to a second aspect of the present invention, the molding die for a resin supplying device is attached around the covering-resin-removed-area of an optical fiber.

In a recoating method for optical fibers according to a third aspect of the present invention, the relative rotation of the covering-resin-removed-area relative to the resin supplying device is performed during the supplying of resin, or after the supplying of resin.

By the recoating method of present invention, because the covering-resin-removed-area of the optical fiber is rotated relatively to the resin supplying device, factors such as characteristics of the resin, inadequate centering of the optical fiber, and inaccurate shape of the dies can be minimized, and therefore an optical fiber of excellent quality in the recoated section is uniform can be obtained.

### BRIEF DESCRIPTION OF THE DRAWINGS

FIG. 1 is a side view of the recoating system of an embodiment of the recoating method of the optical fiber according to present invention.

FIG. 2A is a plan view of the recoating system in FIG. 1 in which the top die is removed. FIG. 2B is a cross section viewed from Y-Y line of FIG. 2A.

FIG. 3 is a side view showing the recoated section of the optical fiber formed by the recoating method as illustrated in FIG. 1.

FIG. 4 shows, vertically, a part of a cross section of an example of the recoating device in the conventional recoating method for an optical fiber.

FIG. 5 is a side view showing other examples of the recoating device in the conventional recoating method for an optical fiber.

FIG. 6 is a plan view of the recoating system in FIG. 5 in which the top die is removed.

FIG. 7 is a side view showing the recoated section of the optical fiber formed by the recoating method of FIG. 4.

FIG. 8 is a side view showing the recoated section of the optical fiber formed by the recoating method of FIG. 5.

FIG. 9 is a cross section along line X-X of the recoated section in FIG. 8.

FIG. 10 is a perspective view showing a light emission introduction section 320a in slit shape and a shading layer 14 in the bottom die 320.

### DETAILED DESCRIPTION OF THE PREFERRED EMBODIMENTS

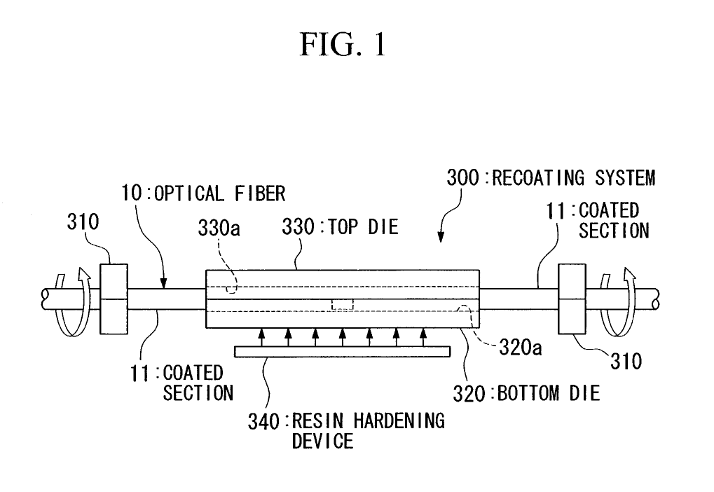

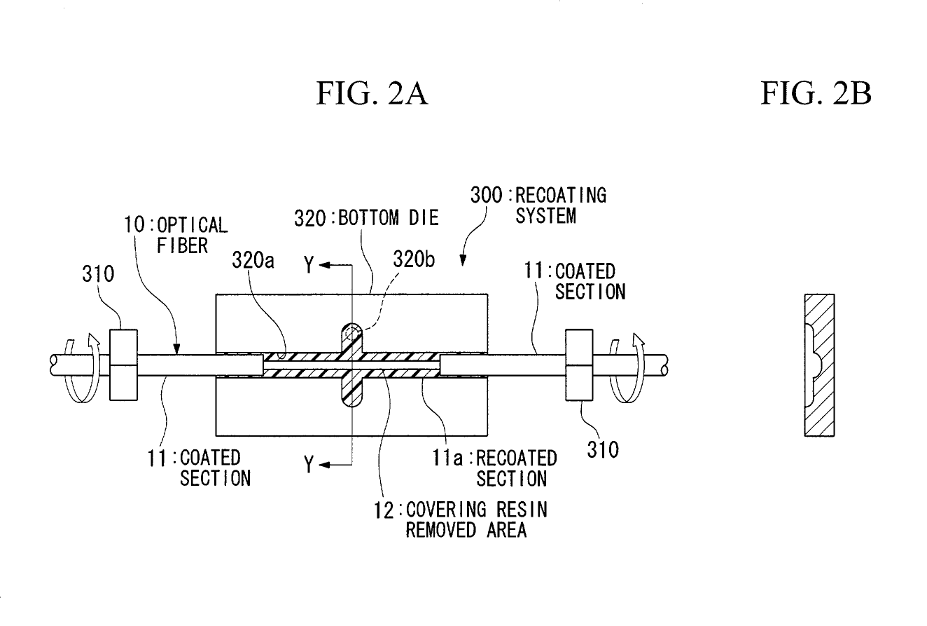

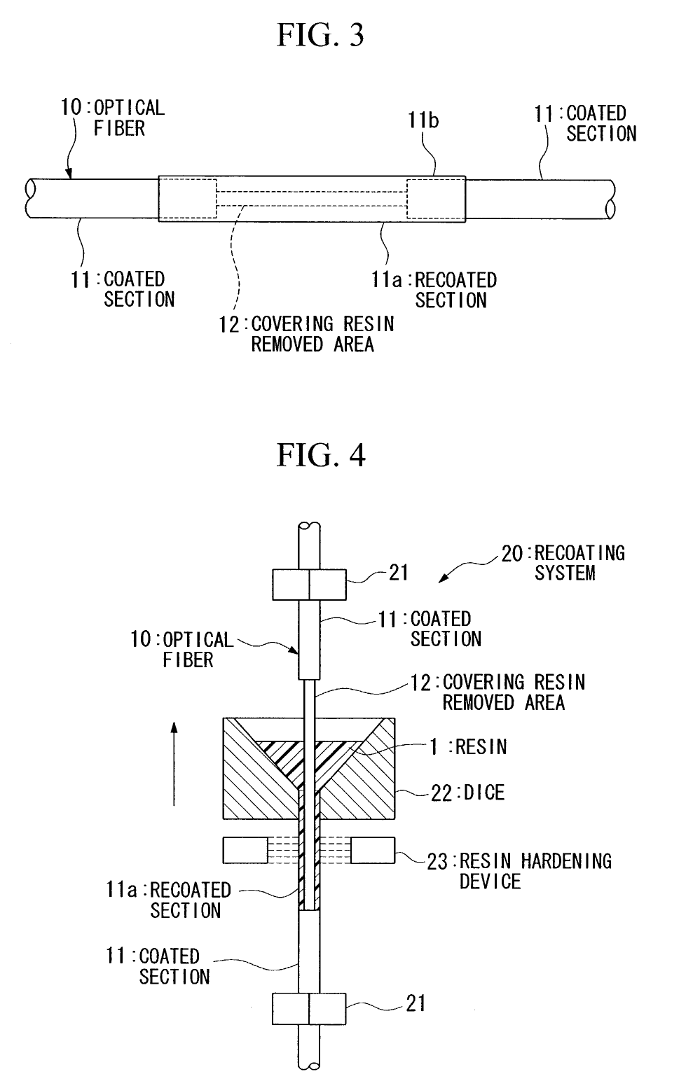

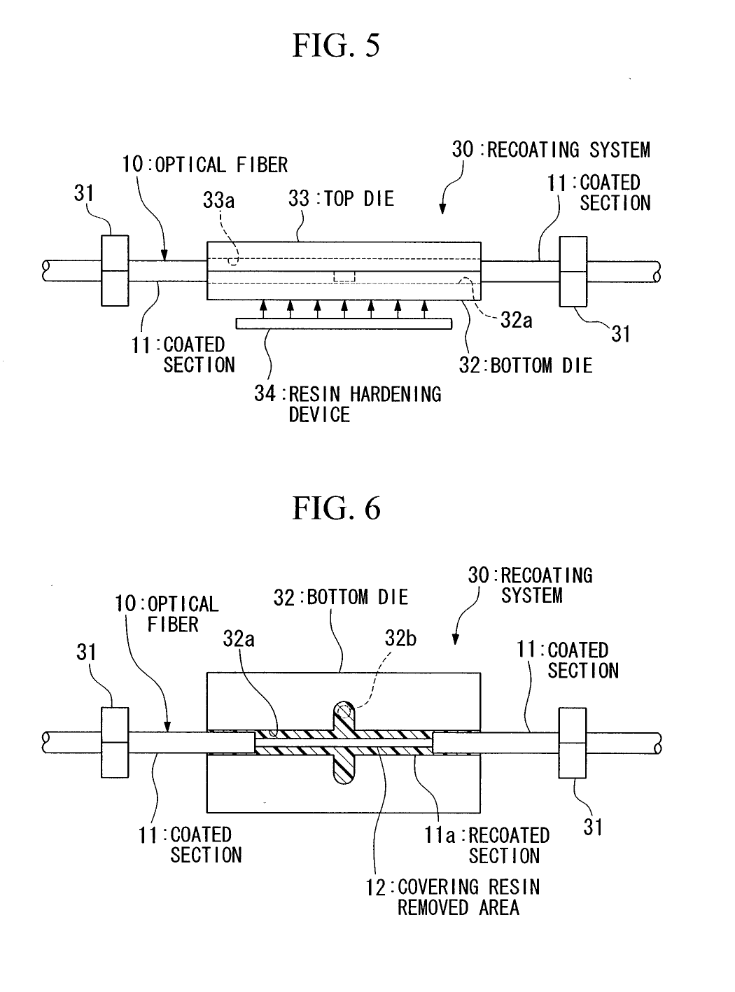

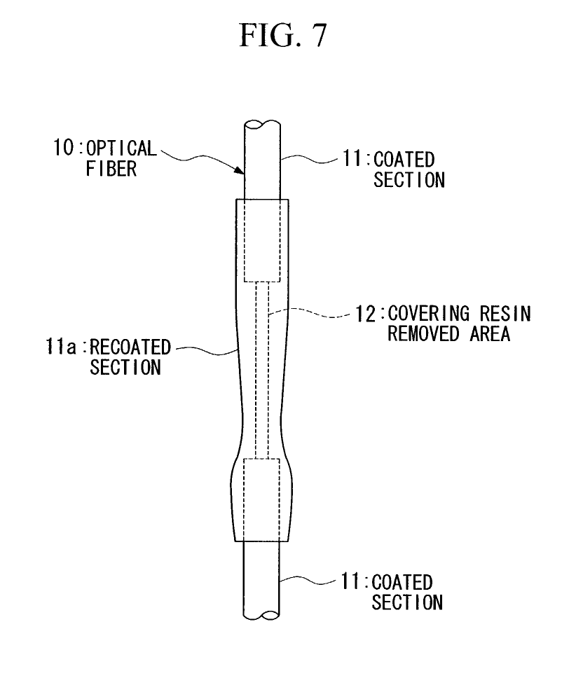

FIGS. 1, 2A, and 2B show an example of the recoating system for performing the recoating method for an optical fiber according to the present invention. This recoating system 300 has nearly the same construction as the recoating device shown in FIGS. 5 and 6.

In this recoating system 300, an optical fiber 10 having the covering-resin-removed-area 12 where the coated section 11 has been removed is first retained by the clamps 310 and 310 horizontally from both sides. Next, while maintaining this position, dies (bottom die and top die) 320 and 330 as a resin supplying device for recoating the resin are set spanning the coated sections 11 and 11 which are on either side of the covering-resin-removed-area 12, and the resin hardening device 340 for emitting radiation such as UV light is set along these dies.

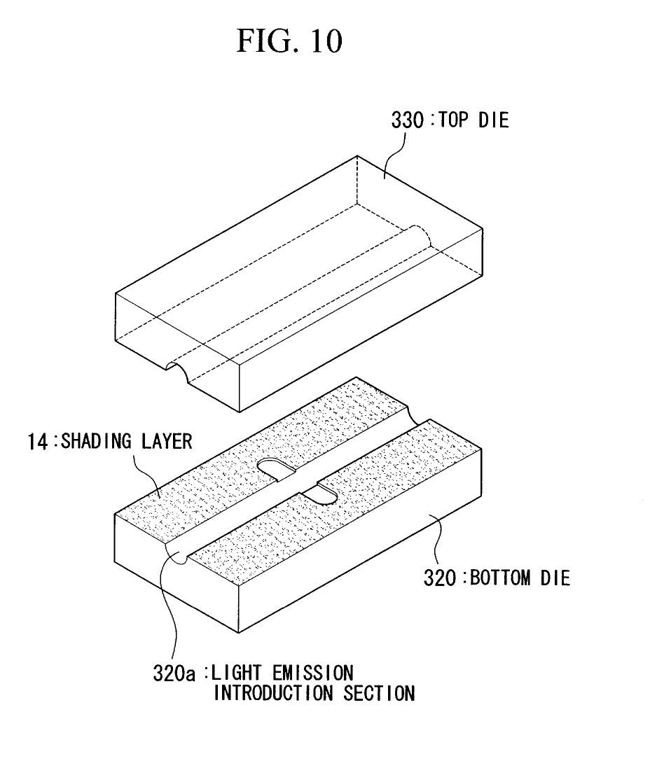

Next, melted resin such as UV curable resin is supplied into the grooves 320a and 330a inside the dies 320 and 330 from the resin supplying port 320b of the bottom die 320, and the UV curable resin inside the die is hardened by emitting UV light from the resin hardening device 340 located alongside. This emission of UV light is performed in such a way that the UV light is stopped down in a slit longitudinally along the optical fiber 10. Also, as a corresponding structure, a light emission introduction section 320a in slit shape may be provided in the bottom die, and a shading layer 14 may be provided on the rest of the bottom die as shown in FIG. 10. By doing this, UV light can be irradiated effectively along the longitudinal direction of the optical fiber 10.

The covering-resin-removed-area 12 of the optical fiber 10 is rotated as shown in the drawing during or after supplying the resin but before the resin is hardened. This rotation is done by a rotating device such as a motor (not shown in the drawing) provided at the clamps on both sides of the optical fiber 10. After the hardening of resins is completed, the molding dies 320 and 330 may be removed.

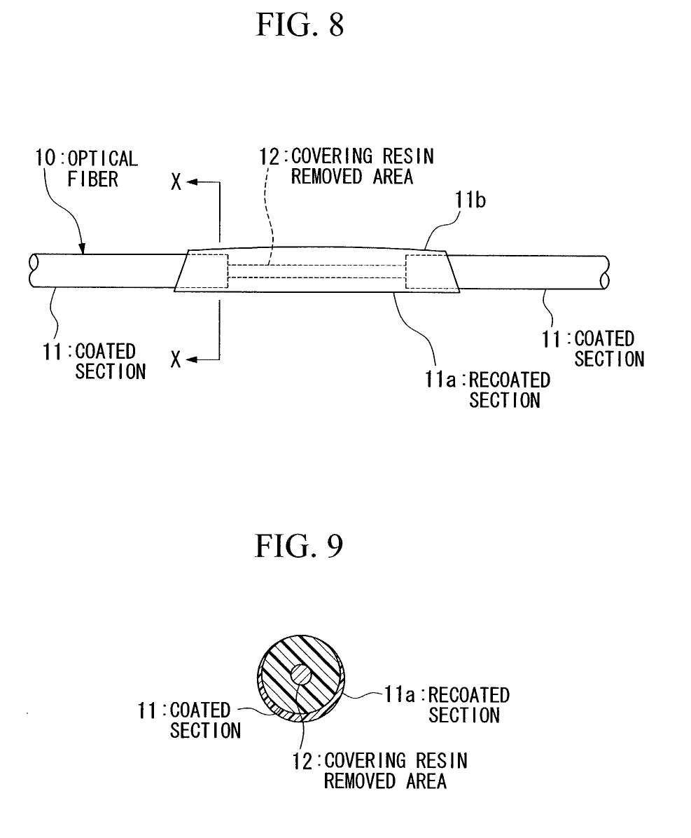

Conventionally, the optical fiber 10 was stationary during the coating with the resin, and therefore the thickness of the resin tended to be nonuniform as shown in FIGS. 8 and 9. However, according to the present invention, if the optical fiber 10 is rotated, a recoated section 11a′ of nearly uniform thickness can be obtained as shown in FIG. 3. Additionally this uniform thickness can be obtained over the entire length between the coated sections 11 and 11. In particular, this uniform thickness can be achieved even on thin section 11b′ where the recoated section and coated section 11 overlap. In conventional methods in which the optical fiber 10 was stationary, the uniform thickness at this overlapping section 11b was particularly difficult because the recoating layer was thin as shown in FIGS. 8 and 9.

The first reason such uniform is possible is believed to be that resin characteristics such as viscosity and the influence of gravity are reduced by an external force such as centrifugal force generated by the rotation, and even if there are problems such as inadequate centering of the optical fiber and inaccurate shape of the dies, these are compensated for to some extent by the rotation.

This also means that accurate uniformity can be achieved even by a relatively less elaborate recoating setting and recoating control. Therefore, the reduced cost of the device and further improved operation is anticipated.

In the recoating method of the present invention, the optical fiber 10 is rotated because it is advantageous to do so. However, the invention is not limited to the rotation of the optical fiber 10. It is also possible to rotate the molding dies 320 and 330 instead. Furthermore, both the optical fiber 10 and molding dies may be rotated. The same operation and the same effect as achieved by the rotation of the optical fiber above can be obtained by such rotation.

Also, in the case in which the UV curable resin is used as a recoating resin, although glass dies are preferably used, this invention is not limited to the glass dies. The dies may also be made of ceramic or metal. In such a case, a device for transmitting the UV light to the UV curable resin must be provided.

Also, as a recoating resin, the resins other than a UV curable resin may be used. In that case, the resin may be hardened by a hardening method which is appropriate for the properties of the resin.

What is claimed is:

1. Recoating method for an optical fiber for recoating a resin on a covering-resin-removed-area of the optical fiber, the method comprising:
rotating the covering-resin-removed-area relatively to a resin supplying device while supplying resin to the covering-resin-removed-area.

2. Recoating method for an optical fiber according to claim 1,
wherein a die as a resin supplying device is provided around the covering-resin-removed-area of the optical fiber.

3. Recoating method for an optical fiber according to claim 1,
wherein the covering-resin-removed-area is rotated relatively to the resin supplying device during or after the supplying the resin.

4. Recoating method for an optical fiber according to claim 1,
wherein resin-hardening-light is radiated to the recoated section while keeping rotating the recoated section after the resin is applied.

5. Recoating method for an optical fiber according to claim 2,
wherein a pair of the top die and the bottom die are separable, and a cavity in which the cover-resin-removed-area is included is formed.

6. Recoating method for an optical fiber according to claim 4,
wherein a resin supplying port which communicates to the cavity is formed on one of the dies.

7. Recoating method for an optical fiber according to claim 4,
wherein a light emission introduction section in slit shape is formed on at least one of the dies, the light introduced from the light emission introduction section is radiated to the recoated resin after the resin is applied while keeping rotating the dies, thus the recoated resin in the cavity is hardened.

8. Recoating method for an optical fiber according to claim 5,
wherein the dies are made of glass, or ceramics.
